(19) United States
(12) Patent Application Publication
(10) Pub. No.: US 2026/0360586 A1
(43) Pub. Date: Nov. 12, 2026

(54) ELASTIC CONDUCTOR AND ELASTIC CONDUCTIVE STRAND WIRE

(71) Applicant: MAEDEN INNOVATION CO., LTD., Taipei City (TW)

(72) Inventor: Tsun Yi KO, Taipei City (TW)

(73) Assignee: MAEDEN INNOVATION CO., LTD., Taipei City (TW)

(21) Appl. No.: 19/246,988

(22) Filed: Jun. 24, 2025

(30) Foreign Application Priority Data
May 9, 2025 (TW) 114204681

(51) Int. Cl. H01B 7/02; H01B 3/30; H01B 7/18

(52) U.S. Cl. CPC H01B 7/0266; H01B 3/30; H01B 7/1865

(57) ABSTRACT

An elastic conductor and an elastic conductive stranded wire are provided. The elastic conductor includes a first elastic wire core and a first metal conducting wire. The first metal conducting wire is spirally wound on the surface of the first elastic wire core along the length direction of the first elastic wire core. The elastic conductive stranded wire includes a plurality of elastic conductors intertwined with each other.

### PRIORITY

This application claims priority to Taiwan Patent Application No. 114204681 filed on May 9, 2025, which is hereby incorporated by reference in its entirety.

### FIELD OF THE INVENTION

The present invention relates to an elastic conductor and elastic conductive strand wire. More specifically, the present invention relates to an elastic conductor and elastic conductive strand wire that are wound and covered in specific ways.

### BACKGROUND OF THE INVENTION

Metal conducting wires can achieve certain effects (e.g., luminescence, heating) after being coated with a polymer layer, thus enabling their application in various fields (e.g., textiles). However, metal conducting wires have poor flexibility and are prone to wear and/or breakage in some application scenarios, which prevent them from being used in operations and applications requiring higher reliability and durability. In light of this, there is an urgent need for a wire that possesses flexibility and is resistant to wear and breakage so as to be used in a wider range of fields.

### SUMMARY OF THE INVENTION

An object of the present invention is to provide an elastic conductor. The elastic conductor comprises a first elastic wire core and a first metal conducting wire. The first metal conducting wire is spirally wound on a surface of the first elastic wire core along a length direction of the first elastic wire core.

In some embodiments of the present invention, the elastic conductor further comprises at least one second metal conducting wire. The at least one second metal conducting wire is spirally wound on the surface of the first elastic wire core along the length direction of the first elastic wire core. The at least one second metal conducting wire have the same or opposite spiral winding directions with each other, and the at least one second metal conducting wire and the first metal conducting wire have the same or opposite spiral winding directions with each other.

In some embodiments of the present invention, the elastic conductor further comprises a first elastic protective layer. The first elastic protective layer covers the first elastic wire core and the first metal conducting wire along the length direction of the first elastic wire core. The first elastic protective layer has a braided structure.

In some embodiments of the present invention, the elastic conductor further comprises a first elastic protective layer. The first elastic protective layer covers the first elastic wire core, the first metal conducting wire, and the at least one second metal conducting wire along the length direction of the first elastic wire core. The first elastic protective layer has a braided structure.

In some embodiments of the present invention, material of the first elastic wire core is at least one of polyurethane, polyolefin, polystyrene, polyether ester, and polyamide.

In some embodiments of the present invention, material of the first elastic protective layer is at least one of polyurethane, polyolefin, polystyrene, polyether ester, and polyamide.

Another object of the present invention is to provide an elastic conductive strand wire. The elastic conductive strand wire comprises a plurality of elastic conductors intertwined with each other. Each of the elastic conductors comprises a first elastic wire core and a first metal conducting wire spirally wound on a surface of the first elastic wire core along a length direction of the first elastic wire core.

In some embodiments of the present invention, each of the elastic conductors further comprises at least one second metal conducting wire spirally wound on the surface of the first elastic wire core along the length direction of the first elastic wire core. The at least one second metal conducting wire have the same or opposite spiral winding directions with each other, and the at least one second metal conducting wire and the first metal conducting wire have the same or opposite spiral winding directions with each other.

In some embodiments of the present invention, each of the elastic conductors further comprises a first elastic protective layer covering the first elastic wire core and the first metal conducting wire along the length direction of the first elastic wire core, wherein the first elastic protective layer has a braided structure.

In some embodiments of the present invention, each of the elastic conductors further comprises a first elastic protective layer covering the first elastic wire core, the first metal conducting wire, and the at least one second metal conducting wire along the length direction of the first elastic wire core, wherein the first elastic protective layer has a braided structure.

In some embodiments of the present invention, material of each of the first elastic wire cores is at least one of polyurethane, polyolefin, polystyrene, polyether ester, and polyamide.

In some embodiments of the present invention, material of each of the first elastic protective layers is at least one of polyurethane, polyolefin, polystyrene, polyether ester, and polyamide.

In some embodiments of the present invention, the elastic conductors that are intertwined with each other form a concentric stranded structure, a flat braided structure, or a circular braided structure.

In some embodiments of the present invention, the elastic conductive strand wire further comprises a second elastic protective layer covering the elastic conductors that are intertwined with each other along a length direction of the elastic conductive strand wire, wherein the second elastic protective layer has a braided structure.

In some embodiments of the present invention, material of the second elastic protective layer is at least one of polyurethane, polyolefin, polystyrene, polyether ester, and polyamide.

According to the above description, the elastic conductor provided by the present invention has higher tensile strength, is more resistant to wear and breakage, and offers flexibility due to comprising elastic wire core and metal conducting wire and even comprising, in some embodiments, an elastic protective layer. The elastic conductive strand wire provided by the present invention has the same advantages because its every elastic conductor also comprises elastic wire core and metal conducting wire and even comprising, in some embodiments, an elastic protective layer.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic diagram of an embodiment of an elastic conductor that comprises an elastic wire core and one single metal conducting wire.

FIG. 1B is a schematic diagram of an embodiment of an elastic conductor that comprises an elastic wire core and two metal conducting wires.

FIG. 1C is a schematic diagram of another embodiment of an elastic conductor that comprises an elastic wire core and two metal conducting wires.

FIG. 2 is a schematic diagram of an embodiment of an elastic conductor that comprises an elastic wire core, two metal conducting wires, and an elastic protective layer.

FIG. 3 is a schematic diagram of an embodiment of an elastic conductive strand wire whose multiple elastic conductors form a concentric stranded structure.

FIG. 4 is a schematic diagram of an embodiment of an elastic conductive strand wire whose multiple elastic conductors form a flat braided structure.

FIG. 4 is a schematic diagram of an embodiment of an elastic conductive strand wire whose multiple elastic conductors form a circular braided structure.

### DETAILED DESCRIPTION

In the following descriptions, elastic conductors and elastic conductive strand wires provided by the present invention will be explained with reference to certain embodiments thereof. However, these embodiments are not intended to limit the present invention to any specific environment, application, or implementations described in these embodiments. Therefore, descriptions of these embodiments are for the purpose of illustration rather than to limit the scope of the present invention. It should be noted that elements unrelated to the present invention are omitted from depiction in the following embodiments and the attached drawings. In addition, dimensions of elements and dimension scales between individual elements in the attached drawings are provided only for ease of depiction and illustration but not to limit the scope of the present invention. Furthermore, unless otherwise specified, the terms “a,” “the,” and similar terms used in this specification and the claims should be understood to include both singular and plural forms.

### 1. Elastic Conductor

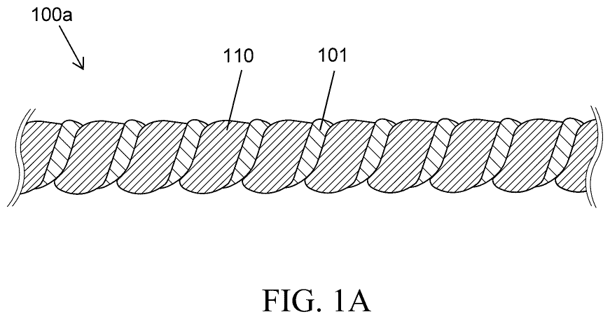

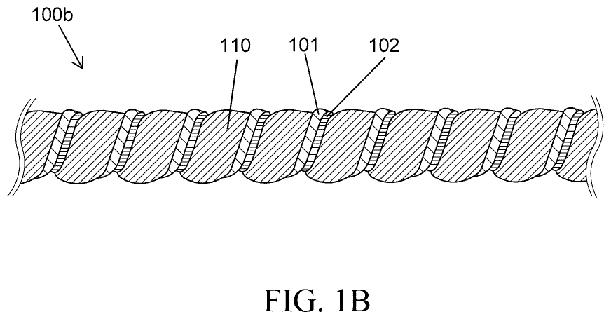

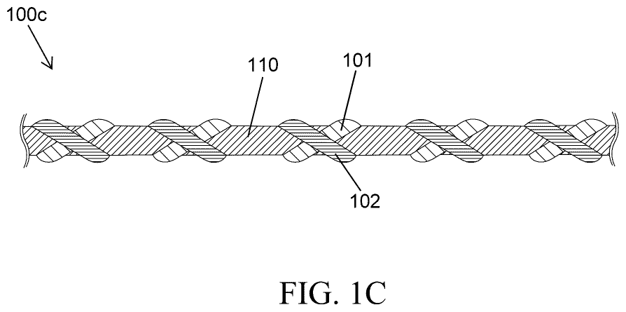

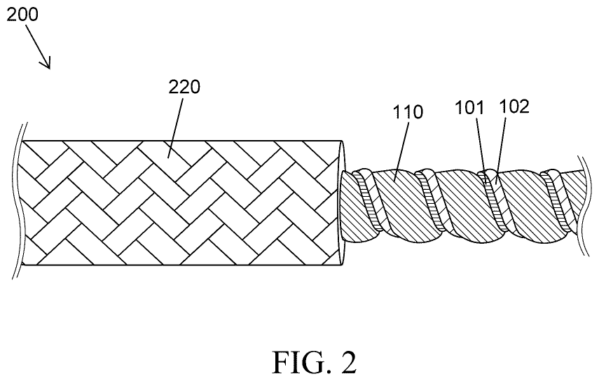

In some embodiments of the present invention, an elastic conductor comprises an elastic wire core and one or more metal conducting wires, wherein the metal conducting wire(s) is/are spirally wound on a surface of the elastic wire core along a length direction of the elastic wire core (e.g., the elastic conductors illustrated in FIG. 1A to FIG. 1C). In some other embodiments of the present invention, an elastic conductor comprises an elastic wire core, one or more metal conducting wires, and an elastic protective layer, wherein the metal conducting wire(s) is/are spirally wound on a surface of the elastic wire core along a length direction of the elastic wire core, the elastic protective layer covers the elastic wire core and the metal conducting wire(s) along the length direction of the elastic wire core, and the elastic protective layer has a braided structure (e.g., the elastic conductor illustrated in FIG. 2).

In an elastic conductor according to the present invention, the number of metal conducting wires is not particularly limited. Specifically, an elastic conductor may comprise one or more metal conducting wires.

FIG. 1A is a schematic diagram of an embodiment of an elastic conductor that comprises an elastic wire core and one single metal conducting wire, wherein the elastic conductor 100a comprises an elastic wire core 110 and a first metal conducting wire 101, and the first metal conducting wire 101 is spirally wound on a surface of the elastic wire core 110 along a length direction of the elastic wire core 110. FIG. 1B is a schematic diagram of an embodiment of an elastic conductor that comprises an elastic wire core and two metal conducting wires, wherein the elastic conductor 100b comprises an elastic wire core 110, a first metal conducting wire 101, and a second metal conducting wire 102, each of the first metal conducting wire 101 and the second metal conducting wire 102 is spirally wound on a surface of the elastic wire core 110 along a length direction of the elastic wire core 110, and the second metal conducting wire 102 and the first metal conducting wire 101 have the same spiral winding direction with each other. FIG. 1C is a schematic diagram of another embodiment of an elastic conductor that comprises an elastic wire core and two metal conducting wires, wherein the elastic conductor 100c comprises an elastic wire core 110, a first metal conducting wire 101, and a second metal conducting wire 102, each of the first metal conducting wire 101 and the second metal conducting wire 102 is spirally wound on a surface of the elastic wire core 110 along a length direction of the elastic wire core 110, and the second metal conducting wire 102 and the first metal conducting wire 101 have the opposite spiral winding directions with each other.

FIG. 2 is a schematic diagram of an embodiment of an elastic conductor that comprises an elastic wire core, two metal conducting wires, and an elastic protective layer, wherein the elastic conductor 200 comprises an elastic wire core 110, a first metal conducting wire 101, a second metal conducting wire 102, and an elastic protective layer 220. Specifically, each of the first metal conducting wire 101 and the second metal conducting wire 102 is spirally wound on a surface of the elastic wire core 110 along a length direction of the elastic wire core 110, and the second metal conducting wire 102 and the first metal conducting wire 101 have the same spiral winding direction with each other. In addition, the elastic protective layer 220 covers the elastic wire core 110, the first metal conducting wire 101, and the second metal conducting wire core 102 along the length direction of the elastic wire core 110, and the elastic protective layer 220 has a braided structure. For better understanding of the structure of the elastic conductor 200, it is noted that a portion of the elastic protective layer 220 is intentionally omitted in FIG. 2 to show that inside the elastic protective layer 220 are the elastic wire core 110, the first metal conducting wire 101, and the second metal conducting wire core 102. However, as described above, the elastic protective layer 220 covers the elastic wire core 110, the first metal conducting wire 101, and the second metal conducting wire 102 along the length direction of the elastic wire core 110.

As described above, an elastic conductor in some embodiments of the present comprises an elastic wire core, one or more metal conducting wires, and an elastic protective layer. Hence, in some embodiments, the elastic wire core and metal conducting wire(s) covered by the elastic protective layer 220 as shown in FIG. 2 may be replaced by those shown in any of FIG. 1A to FIG. 1C.

The elastic conductors provided by the present invention are not limited to the above embodiments but also covers embodiments that comprises more metal conducting wires, e.g., three, four, five, six, seven, eight, nine, or ten metal conducting wires. In embodiments where an elastic conductor comprises multiple metal conducting wires (e.g., the embodiments shown in FIG. 1B, FIG. 1C, and FIG. 2), the advantage is that even if one metal conducting wire is broken, the rest metal conducting wire(s) can still provide conductivity. Therefore, compared with an elastic conductor comprising one metal conducting wire, an elastic conductor comprising multiple metal conducting wires has a longer service life.

In addition, in embodiments where an elastic conductor comprises multiple metal conducting wires (e.g., the embodiments shown in FIG. 1B, FIG. 1C, and FIG. 2), the spiral winding direction of each metal conducting wire is not particularly limited. The metal conducting wires may have the same winding direction (as shown in FIG. 1B) or opposite spiral winding directions with each other. Taking FIG. 1C as an example, from a cross-sectional view of the elastic conductor, the first metal conducting wire 101 and the second metal conducting wire core 102 are spirally wound on a surface of the elastic wire core 110 in a clockwise direction and in a counter-clockwise direction respectively, meaning they are wound in different directions. However, it is noted that the first metal conducting wire 101 and the second metal conducting wire core 102 may both be wound in a clockwise direction or both be wound in a counter-clockwise direction.

Compared to conventional metal conducting wires, the elastic conductor provided by the present invention is resistant to wear and breakage and offers flexibility. Detailed descriptions of each component of the elastic conductor are provided below.

### 1.1 Elastic Wire Core

In the present invention, the elastic wire core is used to offer the elastic conductor good extensibility so that the elastic conductor has excellent flexibility. In some embodiments of the present invention, the elastic wire core has an elongation ratio of 50% to 300%, preferably an elongation ratio of 100% to 200%, e.g., 100%, 105%, 110%, 115%, 120%, 125%, 130%, 135%, 140%, 145%, 150%, 155%, 160%, 165%, 170%, 175%, 180%, 185%, 190%, 195%, or 200% or an elongation ratio within a range formed by any two of the aforementioned values.

The material of the elastic wire core is not particularly limited and may be any conventional elastic material (having good elongation ratio) that can offer the desired elongation ratio so as to achieve the desired flexibility. Examples of the conventional elastic material includes, but not limited to, elastomers, elastic fibers, and elastic alloys. In some embodiments of the present invention, the elastic wire core comprises elastic fiber, or consists essentially of elastic fiber, or consists of elastic fiber. The elastic fibers may be selected from the group comprising: polyurethane elastic fibers, polyolefin elastic fibers, polystyrene elastic fibers, polyether ester elastic fibers, polyamide elastic fibers, and the combination thereof. In some embodiments of the present invention, the elastic wire core consists of polyurethane elastic fibers. In some embodiments, material of the elastic wire core may be at least one of polyurethane, polyolefin, polystyrene, polyether ester, and polyamide.

The size of the elastic wire core is also not particularly limited as long as it is able to provide the desired elasticity and structural strength. In some embodiments of the present invention, the elastic wire core may consist of one or more elastic fibers. Each of the fibers may be independently solid or hollow, and the cross-section of each fiber may be any geometric shape, such as circular, non-circular, triangular, rectangular, hexagonal, etc. ; however, the present invention is not limited to these examples. In some embodiments of the present invention, the elastic wire core consists of elastic fiber(s) with a circular cross-section and the diameter of the elastic wire core may range from 0.2 mm to 10 mm, e.g., 0.3 mm, 0.4 mm, 0.5 mm, 0.6 mm, 0.7 mm, 0.8 mm, 0.9 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, or 10 mm, or within any range formed by two of the aforementioned values.

### 1.2 Metal Conducting Wires (Including the First Metal Conducting Wire and the Second Metal Conducting Wire)

In the present invention, the metal conducting wire(s) is/are used to achieve certain effects such as luminescence and heating. To make the elastic conductor have better extensibility and flexibility, the metal conducting wire(s) is/are spirally wound on the surface of the elastic wire core along the length direction of the elastic wire core according to the present invention. In other words, according to the elastic conductor of the present invention, the metal conducting wire(s) is/are wound on the surface of the elastic wire core along the length direction of the elastic wire core like a spring. Therefore, the extensibility and flexibility of the elastic conductor can be changed by adjusting the pitch of spiral winding. In some embodiments of the present invention, the pitch of the spiral winding may range from 0.2 mm to 7 mm, e.g., 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, or 7 mm, or within a range formed by any two of the aforementioned values. With the aforementioned special structure of the present invention, the metal conducting wire(s) resist(s) breaking during the extension of the elastic conductor, thereby allowing the elastic conductor to have a longer service life.

The type of metal conducting wire(s) (including the first metal conducting wire and the second metal conducting wire) is not particularly limited and may be any conventional metal conducting wire capable of providing electrical conductivity. Examples of the conventional metal conducting wires capable of providing electrical conductivity include, but are not limited to, those selected from the group comprising: pure copper wire, copper alloy wire, enameled copper wire, and enameled copper alloy wire. In aspects where the elastic conductor comprises multiple metal conducting wires, the type of each metal conducting wire may be the same or different.

The size of metal conducting wire(s) (including the first metal conducting wire and the second metal conducting wire) is not particularly limited as long as the metal conducting wire(s) is/are capable of providing electrical conductivity. The cross-section of each metal conducting wire may be any geometric shape, such as circular, non-circular, triangular, rectangular, hexagonal, etc. ; however, the present invention is not limited to these examples. In aspects where the elastic conductor comprises multiple metal conducting wires, the size of each metal conducting wire may be the same or different. In some embodiments of the present invention, the metal conducting wire(s) (including the first metal conducting wire and the second metal conducting wire) is/are with a circular cross-section and the diameter of each may independently range from 0.03 mm to 1.0 mm, e.g., 0.03 mm, 0.04 mm, 0.05 mm, 0.06 mm, 0.07 mm, 0.08 mm, 0.09 mm, 0.1 mm, 0.2 mm, 0.3 mm, 0.4 mm, 0.5 mm, 0.6 mm, 0.7 mm, 0.8 mm, 0.9 mm, or 1.0 mm, or fall within a range formed by any two of the aforementioned values.

### 1.3 Elastic Protective Layer

In the present invention, the elastic protective layer is provided for protecting the inner structure of the elastic conductor and providing excellent flexibility.

The braided structure of the elastic protective layer is not particularly limited and may be the braided structure formed by any conventional braiding methods. Examples of the conventional braiding methods include, but are not limited to, three-strand braiding, four-strand braiding, five-strand braiding, six-strand braiding, seven-strand braiding, eight-strand braiding, or nine-strand braiding, or braided structures formed by other braiding methods.

The material of the elastic protective layer is not particularly limited and may be any conventional elastic material (having good elongation ratio) that can offer the desired elongation ratio so as to achieve the desired flexibility. Examples of the conventional elastic material includes, but not limited to, elastomers, elastic fibers, and elastic alloys. In some embodiments of the present invention, the elastic protective layer comprises elastic fiber, or consists essentially of elastic fiber, or consists of elastic fiber. The elastic fibers may be selected from the group comprising: polyurethane elastic fibers, polyolefin elastic fibers, polystyrene elastic fibers, polyether ester elastic fibers, polyamide elastic fibers, and the combination thereof. In some embodiments, material of the elastic protective layer may be at least one of polyurethane, polyolefin, polystyrene, polyether ester, and polyamide.

### 2. Elastic Conductive Strand Wire

An elastic conductive strand wire, in some embodiments of the present invention, comprises a plurality of elastic conductors intertwined with each other, wherein each elastic conductor is independent with each other and each elastic conductor is an elastic conductor provided by the present invention (e.g., the elastic conductor of any of the aforementioned embodiments). That is, in some embodiments, each elastic conductor comprised in an elastic conductive strand wire comprises an elastic wire core and one or more metal conducting wires spirally wound on a surface of the elastic wire core along a length direction of the elastic wire core (e.g., the elastic conductors illustrated in FIG. 1A to FIG. 1C). In some embodiments, each elastic conductor comprised in an elastic conductive strand wire comprises an elastic wire core, one or more metal conducting wires, and an elastic protective layer, wherein the metal conducting wire(s) is/are spirally wound on a surface of the elastic wire core along a length direction of the elastic wire core, the elastic protective layer covers the elastic wire core and the metal conducting wire(s) along the length direction of the elastic wire core, and the elastic protective layer has a braided structure (e.g., the elastic conductor illustrated in FIG. 2).

An elastic conductive strand wire, in some other embodiments of the present invention, comprises a plurality of elastic conductors intertwined with each other and an elastic protective layer, wherein each elastic conductor is independent with each other, each elastic conductor is an elastic conductor provided by the present invention (e.g., the elastic conductor of any of the aforementioned embodiments), the elastic protective layer covers the elastic conductors that are intertwined with each other along a length direction of the elastic conductive strand wire, and the elastic protective layer has a braided structure.

Compared to conventional metal conducting wires, the elastic conductive strand wire provided by the present invention is resistant to wear and breakage and offers flexibility. Detailed descriptions of the elastic conductive strand wire are provided below.

### 2.1 Structure Formed by the Intertwined Elastic Conductors

As mentioned above, the elastic conductive strand wire provided by the present invention comprises a plurality of elastic conductors intertwined with each other. The elastic conductors may be intertwined with each other into various structures.

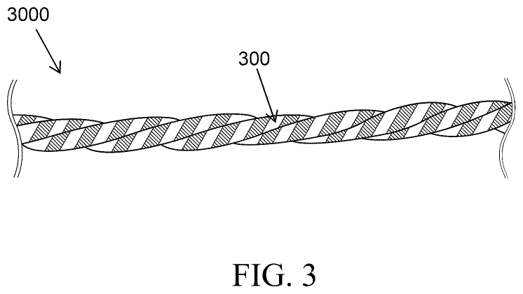

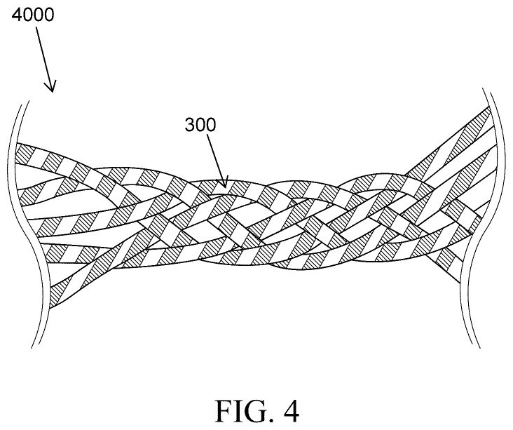

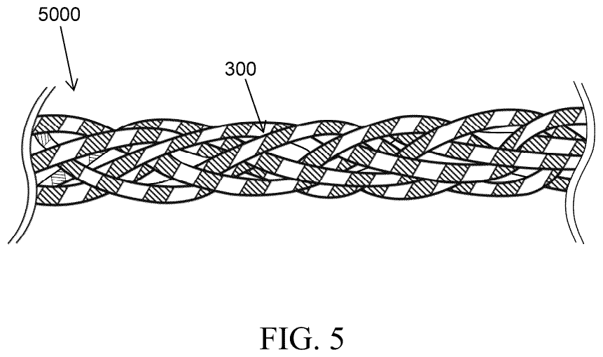

FIG. 3 illustrates an embodiment of the elastic conductive stranded wire 3000 of the present invention whose elastic conductors 300 are intertwined to form a concentric stranded structure, wherein the elastic conductors 300 are independent with each other, and each of the elastic conductors 300 is an elastic conductor provided by the present invention (e.g., elastic conductors 100a, 100b, 100c, 200). FIG. 4 illustrates an embodiment of the elastic conductive stranded wire 4000 of the present invention whose elastic conductors 300 are intertwined to form a flat stranded structure, wherein the elastic conductors 300 are independent with each other, and each of the elastic conductors 300 is an elastic conductor provided by the present invention (e.g., elastic conductors 100a, 100b, 100c, 200). FIG. 5 illustrates an embodiment of the elastic conductive stranded wire 5000 of the present invention whose elastic conductors 300 are intertwined to form a circular stranded structure, wherein the elastic conductors 300 are independent with each other, and each of the elastic conductors 300 is an elastic conductor provided by the present invention (e.g., elastic conductors 100a, 100b, 100c, 200).

### 2.2 Elastic Protective Layer

In the present invention, the elastic protective layer is provided for protecting the inner structure of the elastic conductive stranded wire and providing excellent flexibility.

The braided structure of the elastic protective layer is not particularly limited and may be the braided structure formed by any conventional braiding methods. Examples of the conventional braiding methods include, but are not limited to, three-strand braiding, four-strand braiding, five-strand braiding, six-strand braiding, seven-strand braiding, eight-strand braiding, or nine-strand braiding, or braided structures formed by other braiding methods.

The material of the elastic protective layer is not particularly limited and may be any conventional elastic material (having good elongation ratio) that can offer the desired elongation ratio so as to achieve the desired flexibility. Examples of the conventional elastic material includes, but not limited to, elastomers, elastic fibers, and elastic alloys. The elastic fibers may be selected from the group comprising: polyurethane elastic fibers, polyolefin elastic fibers, polystyrene elastic fibers, polyether ester elastic fibers, polyamide elastic fibers, and the combination thereof. In some embodiments, material of the elastic protective layer may be at least one of polyurethane, polyolefin, polystyrene, polyether ester, and polyamide.

It shall be appreciated that, in the specification and the claims of the present invention, some terms (including metal conducting wire) are preceded by the terms “first” or “second.” It is noted that the terms “first” and “second” are used only for distinguishing different terms. If the order of these terms is not specified or the order of the terms cannot be derived from the context, the order of these terms is not limited by the preceded “first” or “second.”

According to the above description, the elastic conductor provided by the present invention has higher tensile strength, is more resistant to wear and breakage, and offers flexibility due to comprising elastic wire core and metal conducting wire and even comprising, in some embodiments, an elastic protective layer. The elastic conductive strand wire provided by the present invention has the same advantages because its every elastic conductor also comprises elastic wire core and metal conducting wire and even comprising, in some embodiments, an elastic protective layer.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An elastic conductor, comprising:
a first elastic wire core; and
a first metal conducting wire, spirally wound on a surface of the first elastic wire core along a length direction of the first elastic wire core.

2. The elastic conductor of claim 1, further comprising:
at least one second metal conducting wire, spirally wound on the surface of the first elastic wire core along the length direction of the first elastic wire core,
wherein the at least one second metal conducting wire have the same or opposite spiral winding directions with each other, and the at least one second metal conducting wire and the first metal conducting wire have the same or opposite spiral winding directions with each other.

3. The elastic conductor of claim 1, further comprising:
a first elastic protective layer, covering the first elastic wire core and the first metal conducting wire along the length direction of the first elastic wire core,
wherein the first elastic protective layer has a braided structure.

4. The elastic conductor of claim 2, further comprising:
a first elastic protective layer, covering the first elastic wire core, the first metal conducting wire, and the at least one second metal conducting wire along the length direction of the first elastic wire core,
wherein the first elastic protective layer has a braided structure.

5. The elastic conductor of claim 1, wherein material of the first elastic wire core is at least one of polyurethane, polyolefin, polystyrene, polyether ester, and polyamide.

6. The elastic conductor of claim 3, wherein material of the first elastic protective layer is at least one of polyurethane, polyolefin, polystyrene, polyether ester, and polyamide.

7. An elastic conductive strand wire, comprising:
a plurality of elastic conductors intertwined with each other, wherein each of the elastic conductors comprises:
a first elastic wire core; and
a first metal conducting wire, spirally wound on a surface of the first elastic wire core along a length direction of the first elastic wire core.

8. The elastic conductive strand wire of claim 7, wherein each of the elastic conductors further comprises:
at least one second metal conducting wire, spirally wound on the surface of the first elastic wire core along the length direction of the first elastic wire core,
wherein the at least one second metal conducting wire have the same or opposite spiral winding directions with each other, and the at least one second metal conducting wire and the first metal conducting wire have the same or opposite spiral winding directions with each other.

9. The elastic conductive strand wire of claim 7, wherein each of the elastic conductors further comprises:
a first elastic protective layer, covering the first elastic wire core and the first metal conducting wire along the length direction of the first elastic wire core,
wherein the first elastic protective layer has a braided structure.

10. The elastic conductive strand wire of claim 8, wherein each of the elastic conductors further comprises:
a first elastic protective layer, covering the first elastic wire core, the first metal conducting wire, and the at least one second metal conducting wire along the length direction of the first elastic wire core,
wherein the first elastic protective layer has a braided structure.

11. The elastic conductive strand wire of claim 7, wherein material of each of the first elastic wire cores is at least one of polyurethane, polyolefin, polystyrene, polyether ester, and polyamide.

12. The elastic conductive strand wire of claim 9, wherein material of each of the first elastic protective layers is at least one of polyurethane, polyolefin, polystyrene, polyether ester, and polyamide.

13. The elastic conductive strand wire of claim 7, wherein the elastic conductors that are intertwined with each other form a concentric stranded structure, a flat braided structure, or a circular braided structure.

14. The elastic conductive strand wire of claim 7, further comprising:
a second elastic protective layer, covering the elastic conductors that are intertwined with each other along a length direction of the elastic conductive strand wire,
wherein the second elastic protective layer has a braided structure.

15. The elastic conductive strand wire of claim 14, wherein material of the second elastic protective layer is at least one of polyurethane, polyolefin, polystyrene, polyether ester, and polyamide.
